(19) United States
(12) Patent Application Publication
(10) Pub. No.: US 2005/0233059 A1
(43) Pub. Date: Oct. 20, 2005

(54) Textured protein and process for producing processed food using the same

(76) Inventors: Nozomi Harada, Izumisano-shi (JP); Yasuyuki Nakano, Izumisano-shi (JP); Hirohumi Kugitani, Izumisano-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/826,405

(22) Filed: Apr. 19, 2004

(51) Int. Cl. A23L 1/31

(52) U.S. Cl. 426/656

(57) ABSTRACT

A textured protein comprising as main ingredients soybean protein, casein and water, and a frozen processed food in which the textured protein is mixed are disclosed. The textured protein is produced by heating a mixture of soybean protein, casein and water under pressure, followed by extruding the mixture to the atmosphere to expand. The textured protein has function to give a juicy texture of a freshly cooked food to the frozen processed food, even if the food is re-heated upon eating after being frozen and distributed to the market.

### BACKGROUND OF THE INVENTION

1. Technical Field to Which the Invention

The present invention relates to a processed food having a juicy mouthfeel similar to that of a freshly cooked food even after freezing and thawing, and a textured protein to be used for the processed food.

2. Prior Art

With further changes in a social environment such as trends toward double-income families, nuclear families, needs for ready to eat foods are booming year by year, and therefore use of processed meat products or ready to eat side dishes whose main raw material is meat at the table is being increased. However, under the present circumstances, a good taste of a freshly cooked food cannot be given to ready to eat processed foods, though a demand for such a good taste is increasing. In particular, these required a juicy mouthfeel of a freshly cooked food of meat such as hamburgers, meatballs, and Chinese meat dumplings (e.g., jiao-zi, shao-mai, Chinese meat buns, etc.) have a problem that, when eating by re-heating at home and so on after cooked by manufacturers and distributed to the market in the chilled or frozen form, a juicy mouthfeel of a freshly cooked food is hardly expected. To solve this problem, various attempts have been made until now, but no sufficient solution has yet been achieved.

For example, in JP-A 11-103826, MPC (milk protein concentrate) is used for giving a juicy mouthfeel to a processed meat product. Although an effect of giving a juicy mouthfeel to a processed meat product is obtained, MPC has a strong milk flavor and a good product is hardly obtained. For giving a juicy mouthfeel to a processed food, JP-A-2001-118 discloses addition of a material, which is prepared by emulsifying hydrocolloid, oil and water, heating and cutting the emulsion, to dough. However, this requires such complicated steps as emulsification, heating and cutting, and deteriorates workability. In addition, an effect of giving a juicy mouthfeel is insufficient.

On the other hand, conventionally, a textured soybean protein has been produced by extruding vegetative protein materials and so on with heating under pressure. The textured soybean protein produced by such a method has been widely used as a substitute for meat in various processed meat products such as hamburgers, meatballs, Chinese meat dumplings, etc., and these processed meat products have been improved in quality (giving ground meat texture, improving yield, giving soft texture, etc.). However, a juicy mouthfeel has hardly been given thereto.

JP-A 63-192348 discloses a method of producing a food product having a fibrous texture by extruding a mixture of rennet-casein, fats and oils, and soybean protein as an emulsifier with an extruder. However, the soybean protein is used only in a small amount as an emulsifier, and the food product having a fibrous texture obtained is not expanded. JP-A 5-244877 discloses a textured protein food produced by using soybean protein, fats and oils and casein. This food is textured even when an oil content increases. However, only a little expanding is achieved and a water absorbing capacity of the resultant product is small. Therefore, when used in a processed food, an insufficient soft and juicy mouthfeel is given to the food.

### SUMMARY OF THE INVENTION

An object of the present invention is to provide a processed food which has a juicy mouthfeel of a freshly cooked food even if it is re-heated upon eating after being frozen and distributed to the market.

Another object of the present invention is to provide such a textured protein which can give a juicy mouthfeel to a processed food.

These objects as well as other objectives and advantages of the present invention will become apparent to those skilled in the art from the following description.

As a result of the present inventors' intensive study to achieve the foregoing objects, it has been found that a processed food having a juicy mouthfeel similar to that of a freshly cooked food upon re-heated after being frozen and distributed to the market can be obtained by mixing a textured protein comprising as main ingredients soybean protein, casein and water and, optionally starch, which is prepared by heating a mixture of these ingredients under pressure, and extruding into the atmosphere to expand, with raw materials of a processed food. Then, the present invention has been completed.

That is, according to the present invention, there is provided a textured protein comprising as main ingredients soybean, casein and water, which is obtained by heating a mixture of raw materials comprising soybean protein, casein and water under pressure, and extruding the mixture into the atmosphere to expand. Preferably, a ratio of soybean protein/casein in the raw materials is 98/2 to 35/65 (dry solids weight ratio). Preferably, the textured protein further comprises starch in an amount of not more than 60% by weight based on dry solids of the raw materials. Further, the textured protein has, preferably, a 5- to 12-fold by weight water absorbing capacity. Furthermore, the oil content of the textured protein is, preferably, not more than 3% by weight based on dry solids of the raw materials.

The present invention also provides a process for producing the above textured protein, which comprises the steps of:
preparing a mixture of raw materials comprising soybean protein, casein and water, heating the mixture under pressure, and extruding the mixture to the atmosphere to expand.

Furthermore, the present invention provides a process for producing a processed food which comprises the steps of:
mixing the above textured protein and raw materials of the processed food, and molding, cooking and then freezing the resulting mixture.

The textured protein of the present invention is different from the above conventional textured soybean protein as follows.

First, expanding of a conventional textured soybean protein, which is produced by heating soybean protein (particularly, defatted soybeans) in an aqueous system under pressure and extruding it to expand, is less than that of the textured protein of the present invention. In addition, such a conventional textured protein has a coarse and rough mouthfeel after reconstitution with hot water, with lacking a soft and juicy mouthfeel.

Further, a conventional textured soybean protein produced by similarly extruding a mixture of soybean protein and starch are highly expanded and has a large water absorbing capacity after reconstitution with hot water. However, the protein has a sticky and gooey mouthfeel after freezing and thawing, and thus hardly has such a soft and juicy mouthfeel as that of the processed food of the present invention.

Furthermore, a conventional textured soybean protein obtained by similarly extruding soybean protein together with wheat protein and optionally starch may be highly expanded under certain extrusion conditions. However, the resultant textured soybean protein has a firmer and stronger texture than that of the textured protein of the present invention after freezing and thawing, when reconstituted with hot water and use in hamburgers. Thus, a soft and juicy mouthfeel cannot be obtained.

Moreover, expanding of a conventional textured soybean protein obtained by similarly extruding soybean protein together with WPC (milk whey protein) is suppressed, and the protein has a strong texture with a small water absorbing capacity. Therefore, when it is used as such in ready to eat foods such as hamburgers, the resultant food is far from that having a soft and juicy mouthfeel, and requires, for example, addition of a polysaccharide to raw materials of hamburgers.

Although a method for producing a textured protein by using soybean protein and casein and heating them in an aqueous system under pressure, followed by extrusion has been already known in the prior art, this method requires fats and oils and its objective is different from that of the present invention. In fact, even if soybean protein and casein are used together, expanding is suppressed due to the use of fats and oils and the resultant textured soybean protein has a small water absorbing capacity, and is far from that to be used for giving the desired soft and juicy mouthfeel to a processed food.

### DETAILED DESCRIPTION OF THE PREFERRED EMBODIMENTS

Hereinafter, the textured protein of the present invention will be illustrated.

A soybean protein used in the present invention can be selected from the group consisting of defatted soybeans, powdered soybean milk, soybean protein isolates, soybean protein concentrates and a mixture thereof. In view of the flavor, soybean protein isolates are particularly preferably used. Whole soybeans may also be used, but their oil content is about 20% by weight based on dry solids. Then, as described hereinafter, it is of importance to adjust the oil content in the raw materials of the textured protein before heating under pressure and extruding to not more than 3% by weight. Although the amount of soybean protein in the raw materials of the textured protein of the present invention varies depending upon a particular kind of soybean protein, the amount is 98 to 35% by weight, preferably 98 to 45% by weight based on dry solids of the raw materials of the textured protein.

As casein used in the present invention, commercially available one can be used. For example, casein sodium (or sodium caseinate), rennet-casein and so on are preferred. Acid casein can be used by neutralizing it, that is, neutralized acid casein in the form of an alkaline metal salt is preferred. Suitably, casein used in the present invention contains more casein protein than milk products as described hereinafter and usually has a crude protein content of not less than 90% by weight, preferably not less than 95% by weight. In particular, sodium caseinate is preferred.

In general, a spray-dried product of milk from which milk fat has been separated is called as skimmed milk powder and it contains casein, whey protein and whey saccharide. MPC (milk protein concentrate) is a product obtained by removing low molecular fractions such as whey saccharide from skimmed milk powder, and contains casein and whey protein. Further, casein can be separated from skimmed milk powder by acid precipitation or rennet-curd precipitation and separation of whey saccharide from the remaining whey gives WPC (whey protein concentrate). The milk products such as the above skimmed milk powder, MPC and WPC contain components other than casein and their casein protein content is low. Further, they are not in the form of an alkaline metal salt such as sodium caseinate. Therefore, they have little effect on the achievement of the objectives of the present invention.

As in the present invention, expanding is promoted by heating soybean protein and casein together in an aqueous system under pressure and extruding the resultant mixture. However, when using soybean protein together with skimmed milk powder, only inferior expanding is resulted and a strong milk flavor of skimmed milk powder may adversely influence quality in some cases depending upon a kind of processed foods. Similarly, when using soybean protein together with MPC, a strong milk flavor of MPC may also adversely influence quality in some cases depending upon a kind of processed foods. In addition, when using a soybean protein together with WPC, expanding tends to be further suppressed. When expanding is suppressed as described above and a water absorbing capacity is small, it is difficult to give a soft and juicy mouthfeel to a processed food. In the present invention, the suitable amount of casein in the raw materials of textured protein is 2 to 65% by weight, preferably 2 to 55% by weight based on dry solids.

The amount of water used in the present invention is not specifically limited, but can be adjusted during operation of an extruder so that the desired textured protein can be sufficiently expanded.

Further, preferably, fats and oils are not added in the present invention. Even in case of addition of fats and oils and using fats and oils having a high oil content, it is preferred to adjust the oil content of the raw materials before heating under pressure and extruding for expanding to not more than 3% by weight, preferably not more than 2% by weight, more preferably not more than 1% by weight based on dry solids. Also in case of using other materials together with soybean protein and casein as main ingredients, it is necessary to adjust the oil content as low as possible in order to promote expanding of the resultant textured protein. When a mixture of raw materials having a high oil content is extruded with an extruder, expanding is suppressed and the resultant textured protein has a small water absorbing capacity, and thus it is difficult to give a soft and juicy mouthfeel to a processed food.

In the production of the textured protein of the present invention, starch can be used together with soybean protein and casein, if necessary. When starch is used, cost reduction may be expected, but too much starch is not preferred because, when a processed food using a textured protein containing too much starch is frozen and thawed, the food has a sticky and gooey mouthfeel (this is a soft mouthfeel but not juicy). Accordingly, in the present invention, the starch content is not more than 60% by weight based on dry solids even in case that the starch content in the raw materials of the textured protein is higher than the protein content of soybean protein. In case of using ordinary soybean protein, the starch content is preferably not more than 30% by weight based on dry solids. When a starch content is outside the above range, starchy nature is significantly revealed and a gooey inferior mouthfeel tends to be developed. This is undesired. For achieving the objectives of the present invention, starch is not indispensable, but preferably formulated in the textured soybean protein from the viewpoint of achievement of the object at a lower cost.

In the present invention, for example, starch may be selected from the group consisting of sweet potato, potato, corn, tapioca, rice, barley, oat, rye, buckwheat, wheat, and cassava, and crude or refined starch derived from these potatoes and cereals; modified starch thereof such as a starch, baked starch, and hydrolyzed starch thereof; starch derivatives; alkali starch; fractionated starch; physically treated starch; and a mixture thereof.

Although the protein content varies depending upon a kind of soybean protein and a kind of casein, in the present invention, the suitable ratio of casein/soybean protein in the raw materials of the textured protein is 98/2 to 35/65 (weight ratio based on dry solids), preferably 98/2 to 45/55. When the ratio is outside this range, a soft and juicy mouthfeel is hardly expected. That is, the effect of giving a soft and juicy mouthfeel is obtained in the ratio within the above range. In case of a lower casein content and a higher soybean protein content, in addition to insufficient expanding, the resultant textured protein has a strong texture. Therefore, when such a textured protein is used in a processed food, a juicy mouthfeel cannot be obtained and the processed food has a hard mouthfeel. Sometimes, this is unsuitable for a processed food having a soft texture. In case of an excess casein content and a too low soybean protein content, expanding of the resultant textured protein is suppressed and its water absorbing capacity becomes small. That is, when such a textured protein is used in a processed food, an effect of giving a soft and juicy mouthfeel cannot be obtained. This is due to heat-meltable protein of casein which suppresses expanding by heating under pressure.

In addition to the above main ingredients, protein other than soybean protein and casein as well as raw materials other than protein may be used together, if necessary. For example, these materials can be select from the group consisting of proteins origined from animals and/or microorganisms, oilseed plants, grain seeds and a mixture thereof. In addition to starch, other carbohydrates, polysaccharides, gums and so on may also be used together.

In the present invention, as an apparatus to be used for the step of heating under pressure and extruding into the atmosphere, a known apparatus can be used, and an extruding machine (extruder) is suitable. As an extruder used in the present invention, a known extruder can be used. Although a single-screw extruder may be used in order to confirm the effect of the present invention, a twin or more-screw extruder is preferably used for stable expanding and discharge. That is, if the oil content of raw materials is not more than 1% by weight, the textured protein obtained by using soybean protein and casein together can be expanded even with a single-screw extruder and a soft and juicy mouthfeel can be given. However, if the oil content exceeds 1% by weight, expanding of the textured protein with a single-screw extruder is suppressed and insufficient for giving the desired juicy mouthfeel. In the case of using a twin-screw extruder, up to 3% by weight of the oil content, expanding sufficient for giving the desired soft and juicy mouthfeel can be achieved. Therefore, a multiple-screw extruder having not less than two screws is preferred. An extruder having mechanisms for feeding raw materials with a screw into a barrel, mixing, compressing and heating the raw materials, and further having a die which attached to a tip barrel can be used. The barrel may be jacketed or may not, and may be heated or cooled by this or may not.

The conditions for texturing the textured protein may be determined experimentally depending upon the objective textured protein. Specifically, the suitable amount of water used for texturing is 15 to 50% by weight, preferably 20 to 45% by weight in terms of water contained in dough including water in raw materials fed to an extruder and added water. By adjusting the amount of water to this range, the desired expanded textured protein can be obtained. Further, for texturing the protein, extrusion is suitably performed at a tip barrel temperature of 140° C. and 190° C., preferably to 150° C. to 185° C. under pressure of 5 and 50 kg/cm².

The textured protein thus obtained can be cut into suitable size with a cutter, a grinder, etc. In case of using this textured protein for producing a processed food using ground meat such as hamburgers, etc., preferably, its grain size is adjusted to that of ground meat. This textured protein may be used in the dried form. In this case, drum drying, fluid bed drying, tray drying, freeze drying and so on can be employed.

Hereinafter, expanding will be illustrated. As a suitable indication of expanding, a water absorbing capacity is used. As a textured protein is more expanded, a water absorbing capacity becomes larger, and the resultant textured protein has a more superior effect of giving a soft and juicy mouthfeel to a processed food. A water absorbing capacity is determined as follows. In Examples hereinafter, a water absorbing capacity is determined according to the same manner.

Determination of a Water Absorbing Capacity

A sample to be evaluated (30 g) is placed in a 500 ml beaker, water at 25° C. (450 g) is added thereto, and the mixture is allowed to stand for 10 minutes. After draining off water for one minute with a 30-mesh sieve (opening: 500 μm) placed on a colander, weight (W) of a water-reconstituted sample on the sieve is measured, and then, the rate of expansion (X) by water absorption is calculated by the following formula.
X=(W−30)/30

The textured protein of the present invention obtained has preferably a water absorbing capacity of 5- to 12-fold based on the weight of the textured product (reconstituted with 15-fold by weigh of water at 25° C., for 10 minutes and drained for one minute on a colander), and the water content thereof is preferably not more than 15% by weight. If a water absorbing capacity is less than 5-fold by weight, it is difficult to give a soft and juicy mouthfeel sufficiently to a processed food. Further, a water absorbing capacity may exceed 12-fold by weight, but usually a textured product having more than 12-fold by weight water absorbing capacity is hardly obtainable.

The processed food of the present invention is produced by mixing the above textured protein and raw materials of the processed food, and molding, cooking, and then freezing the resultant mixture. When a water content of raw materials of the processed food is very high, reconstitution of the textured protein with water is not necessarily required. However, usually, it is suitable to use the textured protein after reconstitution with water in an amount of less than that of its water absorbing capacity. Instead of water, an aqueous solvent such as a seasoning of flavoring solution may be used. The mixing may be performed with a known apparatus, and if necessary kneading may be employed. Although the molding varies depending upon the desired processed food, a known molding apparatus may be used. The cooking may be performed by appropriately heating according to the desired processed food. The freezing may be performed with a known freezer, and quick-freezing is preferred rather than slow-freezing.

Hereinafter, the processed food using the textured protein of the present invention will be specifically illustrated. The processed food is not specifically limited in so far as it is a frozen food and is required to have a similar juicy mouthfeel as that prior to freezing upon being thawed. The processed food may be any of animal origin and plant origin in so far as it is a processed food contains the textured protein of the present invention, and is produced by mixing and optionally kneading the textured protein with raw materials of the processed food, molding, preferably heat-cooking, and then freezing. Although the amount of the textured protein added to a processed food varies depending upon a particular kind of processed foods, the water-reconstituted textured protein is preferably used in an amount of 5 to 80% by weight, more preferably 10 to 60% by weight based on dough prepared with raw materials of the processed food. Although the amount of the texture protein varied depending upon a kind of processed foods, when the amount of the water-reconstituted textured protein is too small, the desired juicy mouthfeel is hardly given, while characteristic properties of the processed food are lost in case of using an excess amount of the water-reconstituted textured protein.

A vegetative processed food may be obtained, for example, by mixing the textured protein of the present invention with tofu (soybean curd) and, optionally, seasoning, and the heating and freezing; by mixing or kneading the textured protein of the present invention with so-called bean curd prepared by coagulating soybean protein with an alkaline earth metal or bittern for tofu, cooking and then freezing; or the like.

As more specific examples of an animal processed food, there are side dishes prepared with ground meat and the like. Examples thereof include hamburgers, meatballs, Chinese meat dumplings (e.g., jiao-zi, shao-mai, Chinese meat buns, etc.), chicken nuggets, sausages and so on. For example, a process for producing a hamburger will be described hereinafter. The textured protein which has been previously reconstituted with water in an amount within its water absorbing capacity can be used by mixing with ground meat and so on. For adding water to the textured protein, in addition to reconstitution with water, a flavoring or seasoning solution to which one or more of soy sauce, liquor, table salt, spices, extracts, sugars, fat-and-oil, egg and so on are added may be used. Further, the textured protein may be used by reconstituting it by addition of water of an amount corresponding to its water absorbing capacity, or may be used by reconstituting it by addition of water of an amount less than its water absorbing capacity with considering a water content of dough or water migration upon heating and the like. Furthermore, in case of focusing on workability, the textured protein in the dry form as such may be added directly. First, ground meat is stirred with a mixer and so on, and is added in turn the textured protein, egg, fresh cream, seasoning, vegetable, starch, bread crumbs and so on, followed by mixing to obtain dough. The dough is then molded and treated by heating so that the center temperature reaches 80° C. or higher. The heat treatment can be performed by baking, steaming, boiling, frying and so on. The processed food thus cooked by heating is then frozen.

The processed food of the present invention is characterized in that it has a similar soft and juicy mouthfeel as that of a freshly cooked food, even if the processed food is re-heated to be eaten after freezing and thawing.

The following Examples will further illustrate the present invention in detail, but are not to be construed to limit the scope of the present invention. In the following Examples, all percents are by weight unless otherwise stated.

Row materials for extrusion

The raw materials used in Examples are as follows.

Defatted soybean powder used was manufactured by Fuji Oil Co., Ltd (protein: 55% in terms of dry solids; moisture: 6%).

Soybean protein powder used was “FUJIPRO-R” manufactured by Fuji Oil Co., Ltd (protein: 91% in terms of dry solids; moisture: 6%).

Casein-Na used was “sodium caseinate” manufactured by Murray Goulburn Cooperative Co. Ltd (protein: 95% in terms of dry solids; moisture: 4%).

MPC used was “MPC-UF80” manufactured by Milcoat (protein: 84% in terms of dry solids; moisture: 4%).

WPC used was “Calpro WPC8002” manufactured by Calpro ingredients (protein: 78.8% in terms of dry solids; moisture: 4.4%).

Wheat gluten used was “A-Glu SS” manufactured by Glico Foods Co., Ltd (protein: 77.5% in terms of dry solids; moisture: 5%).

Starch used was “corn starch” manufactured by Sanwa Denpun K. K (protein: 0% in terms of dry solids; moisture: 13%).

Edible vegetable fats and oil used was “refined soybean oil” manufactured by Fuji Oil Co., Ltd (protein: 0% in terms of dry solids; moisture: 0%)

Preparation of Textured Protein with Extruder

Textured proteins were prepared with an extruder under the following conditions. The raw materials were mixed uniformly with a powder stirrer, etc., and fed to an extruder (KEI45-25 manufactured by Kowa Kogyo Co., Ltd.) with water. Operating conditions were shown in Table 1. The textured protein discharged from the extruder was cut into about 10 mm long with a cutter, roughly ground to the following grain size with a grinder, and then dried with a drier so that the water content became 10%.

TABLE 1
Extruder operating conditions

| | |
|---|---|
| raw materials feeding rate | 20 kg/hr |
| water addition rate | 8 L/hr |
| screw rotation speed | 200 r.p.m. |
| product temperature of the front | 30 to 100° C. |
| part of barrel | |
| product temperature of the rear | 100 to 180° C. |
| part of barrel | |

grain size distribution of textured protein:
JIS standard sieve

| | | |
|---|---|---|
| 2.5 | mesh on (opening: 8.00 mm) | 0% |
| 4 | mesh on (opening: 4.75 mm) | 30% |
| 6 | mesh on (opening: 3.36 mm) | 40% |
| 10 | mesh on (opening: 1.70 mm) | 20% |
| 10 | mesh pass (opening: 1.70 mm) | 10% |

Method for Evaluating Textured Protein

“Evaluation of Textured Protein Alone”

The determination of a water absorbing capacity was described hereinabove.

Evaluation Conditions of Mouthfeel and Flavor

Each textured protein was reconstituted by adding water at 25° C. in an amount corresponding to its water absorbing capacity (for example, in case of a water absorbing capacity of 3-fold by weight, 3 parts by weight of water per 1 part by weight of the textured protein), and then allowing to stand for 10 minutes or longer in order to ensure complete absorption of water. The water-reconstituted textured protein obtained was evaluated by 10 expert panelists with scoring the mouthfeel and flavor according a 10-point scale. For the mouthfeel, the tenderest (soft) textured protein was scored as 10 and, as the mouthfeel became less tender, a lower point was scored. For the flavor, a tasteless and odorless texture protein was scored as 10 and, as the flavor such as a soybean flavor or milk flavor became stronger, a lower point was scored.

“Evaluation of Textured Protein in Mixture (Processed Food)”

An effect of each textured protein used in a processed food (for example, hamburger, meatball, jiao-zi) was evaluated by using dough having the formulation as described in each Example which was cooked under the following conditions. The textured protein used in the formulation of dough was reconstituted with water at 25° C. in an amount corresponding to its water absorbing capacity, and then allowed to stand for 10 minutes or longer in order to ensure complete water absorption by the textured protein.

Cooking Conditions of Hamburger Dough

Hamburger dough (100 g/a piece) was molded and baked at 200° C. for 8 minutes in an oven to obtain a hamburger. Upon molding the dough, an operator evaluated moldability with the most moldable being scored as 0.10. As moldability became more inferior, a lower point was scored.

Cooking Conditions of Meatball Dough

Meatball dough (15 g/a piece) was molded, fried in oil at 175° C. for 30 seconds, and then boiled at 85° C. for 10 minutes to obtain a meatball. Upon molding the dough, an operator evaluated moldability with the most moldable being scored as 10. As moldability became more inferior, a lower point was scored.

Cooking Conditions of Jiao-Zi Dough

A Jiao-zi (20 g/a piece) was prepared by encrusting meat ingredients with dough, fried in oil at 175° C. for 30 seconds, and then boiled at 90° C. for 10 minutes. Upon molding the dough, an operator evaluated moldability with the most moldable being scored as 10. As moldability became more inferior, a lower point was scored.

Evaluation of Hamburger, Meatball and Jiao-Zi

Regarding the jiao-zi, after frozen, it was heated with a flying pan, and was evaluated by 10 expert panelists with scoring the mouthfeel and flavor according a 10-point scale. The best one was scored as 10. For the juicy mouthfeel, the juiciest mouthfeel was scored as 10 and, as the mouthfeel became less juicy with increasing dryness, a lower point was scored. For the soft mouthfeel, the tenderest (soft) one was scored as 10 and, as the mouthfeel became less tender, a lower point was scored. For the flavor, one having a palatable meat taste was scored as 10, and, as a flavor other than meat became stronger, a lower point was scored.

Abbreviations of Processed Foods in Examples

H: hamburger, M: meatball, G: jiao-zi
H1 and H2 were hamburgers prepared using textured proteins A1 and A2 (Table 2), respectively.
In (1) and (2), the textured protein was used, but the amounts of water were different from each other.
H0 was a hamburger prepared without using a textured protein.

### EXAMPLE 1

### EXAMPLE 1-A

The formulation of the raw materials shown in Table 2 below was fed to an extruder to obtain a textured protein. The textured protein thus obtained was evaluated according to the above “evaluation of textured protein alone”.

TABLE 2

| textured protein | A1 | A2 |
|---|---|---|
| (formulation of raw materials (%)) | | |
| defatted soybeans | 100 | 85 |
| casein-Na | — | 15 |
| (evaluation) | | |
| water absorbing capacity (fold) | 3.1 | 6.0 |
| soft mouthfeel (point) | 4.3 | 7.2 |
| flavor (point) | 2.9 | 5.4 |

### EXAMPLE 1-B

Each textured protein obtained in Example 1-A and water were mixed with 21.0 g of ground pork, 23.0 g of ground beef, 3.5 g of lard, 20.0 g of onion, 2.5 g of frozen whole egg, 2.5 g of fresh cream, 5.0 g of bread crumbs, 2.0 g of seasonings and 0.5 g of spices, as shown in Table 3 to prepare 100 g of hamburger dough, which was evaluated according to the above “evaluation of textured protein in mixture (processed food—hamburger)”.

TABLE 3
(unit: g)

| | processed food | | | | |
|---|---|---|---|---|---|
| | H1 | H2 | H0 | H0 | H1 |
| | (1) | (1) | (1) | (2) | (2) |
| water-reconstituted | 20.0 | 20.0 | — | — | 20.0 |
| textured product | | | | | |
| (water) | 15.1 | 17.1 | — | 20.0 | 17.1 |
| (textured protein A1) | 4.9 | — | — | — | 2.9 |
| (textured protein A2) | — | 2.9 | — | — | — |
| juicy mouthfeel X | 9.7 | 9.7 | 9.5 | 9.7 | 9.8 |
| (point) | | | | | |
| juicy mouthfeel Y | 3.4 | 8.0 | 3.4 | 4.0 | 4.4 |
| (point) | | | | | |
| soft mouthfeel X | 4.2 | 7.4 | 2.0 | 6.9 | 6.3 |
| (point) | | | | | |
| soft mouthfeel Y | 4.1 | 7.4 | 2.0 | 6.1 | 5.4 |
| (point) | | | | | |
| flavor X (point) | 5.4 | 7.8 | 10.0 | 4.8 | 6.7 |
| flavor Y (point) | 5.2 | 7.8 | 9.8 | 4.5 | 6.5 |
| moldability (point) | 10.0 | 10.0 | 10.0 | 4.0 | 7.0 |

X: a freshly cooked food
Y: re-heated after freezing

As shown in Examples 1-A and 1-B, the textured protein A2 was excellent in a soft mouthfeel and a flavor in comparison with the textured product A1. Further, the processed food H2 (1) was excellent in a soft mouthfeel of a freshly cooked food and function of sufficiently maintaining a juicy mouthfeel after freezing and re-heating in comparison with the processed food H1 (1). Thus, when used in a processed food, the textured protein A2 gave a soft mouthfeel of a freshly cooked food to a processed food and had function of sufficiently maintaining a juicy mouthfeel after freezing and re-heating. The processed food H0 (1), which was prepared without using a textured protein, had little juicy mouthfeel after freezing and re-heating.

As seen from the above, the processed food H1 (1) using the conventional textured protein A1 whose main ingredient was defatted soybeans had little juicy mouthfeel after freezing and re-heating. In contrast to this, the processed food H2 (1) using the textured protein A2 had a juicy mouthfeel after freezing and re-heating. Assuming that this difference was caused by the difference in the amount of water rather than the use of soybean protein together with casein, the processed food H0 (2) was prepared by simply adding water to hamburger dough. On the other hand, the processed food H1 (2) was prepared by reconstituting the textured protein A1 with water in an amount corresponding to its water absorbing capacity and added the reconstituted textured protein to the dough. As shown in Example 1-B, the processed food H0 (1) prepared by simply increasing the amount of water was problematic because the dough before baking was too tender to be molded, and it scarcely had a juicy mouthfeel as with the processed food H1 (1). Similarly, the processed food H0 (2), in which the textured protein was reconstituted with water in excess over its water absorbing capacity, was problematic because the dough was too tender to be mold, and it scarcely had a juicy mouthfeel as with the processed food H1 (1), though it had a soft mouthfeel. Thus, the processed food prepared by simply added water, or adding the textured protein reconstituted with water in excess over its water absorbing capacity did not have a juicy mouthfeel, though a soft mouthfeel could be given. It was considered that a soft and juicy mouthfeel could be given by using the textured protein having a high water absorbing capacity (preferably 5-fold or more) and retaining water in an amount corresponding to its water absorbing capacity.

Such a textured protein is the desired one and can be given a similar juicy mouthfeel as that of before frozen even after freezing and thawing, when used in a hamburger.

### EXAMPLE 2

### EXAMPLE 2-A

Textured proteins were obtained by feeding the formulations of raw materials in Table 4 to an extruder. Each textured protein obtained was evaluated according to the above “evaluation of textured protein alone”.

TABLE 4

| | textured protein | | | | | |
|---|---|---|---|---|---|---|
| | A1 | A2 | A3 | A4 | A5 | A6 |
| (formulation of raw materials | | | | | | |
| (%)) | | | | | | |
| defatted soybeans | 100 | 85 | — | — | — | — |
| powdered soybean protein | — | — | 100 | 85 | 81 | 77 |
| casein-Na | — | 15 | — | 15 | 14 | 13 |
| edible vegetable fats and oils | — | — | — | — | 5 | 10 |
| (evaluation) | | | | | | |
| water absorbing capacity | 3.1 | 6.0 | 4.9 | 7.1 | 4.9 | 2.7 |
| (fold) | | | | | | |
| soft mouthfeel (point) | 4.3 | 7.2 | 5.0 | 9.5 | 5.1 | 2.6 |
| flavor (point) | 2.9 | 5.4 | 6.7 | 9.5 | 9.5 | 9.5 |

### EXAMPLE 2-B

Each textured protein obtained in Example 2-A and water was mixed with 21.0 g of ground pork, 23.0 g of ground beef, 3.5 g of lard, 20.0 g of onion, 2.5 g of frozen whole egg, 2.5 g of fresh cream, 5.0 g of bread crumbs, 2.0 g of seasonings and 0.5 g of spices to prepare 100 g of hamburger dough, which was evaluated according to the above “evaluation of textured protein in mixture (processed food—hamburger)”.

TABLE 5
(unit: g)

| | processed food | | | | | |
|---|---|---|---|---|---|---|
| | H1 | H2 | H3 | H4 | H5 | H6 |
| | (1) | (1) | (1) | (1) | (1) | (1) |
| water-reconstituted | 20.0 | 20.0 | 20.0 | 20.0 | 20.0 | 20.0 |
| textured protein | | | | | | |
| (water) | 15.1 | 17.1 | 16.1 | 17.5 | 16.6 | 14.6 |
| (textured protein A1) | 4.9 | — | — | — | — | — |
| (textured protein A2) | — | 2.9 | — | — | — | — |
| (textured protein A3) | — | — | 3.4 | — | — | — |
| (textured protein A4) | — | — | — | 2.5 | — | — |
| (textured protein A5) | — | — | — | — | 3.4 | — |
| (textured protein A6) | — | — | — | — | — | 5.4 |
| (evaluation) | | | | | | |
| juicy mouthfeel X | 9.7 | 9.7 | 9.5 | 9.8 | 9.6 | 9.5 |
| (point) | | | | | | |
| juicy mouthfeel Y | 3.4 | 8.0 | 4.2 | 9.6 | 5.3 | 3.4 |
| (point) | | | | | | |
| soft mouthfeel X | 4.2 | 7.4 | 6.2 | 9.6 | 5.3 | 2.5 |
| (point) | | | | | | |
| soft mouthfeel Y | 4.1 | 7.4 | 5.1 | 9.6 | 5.3 | 2.5 |
| (point) | | | | | | |
| flavor X (point) | 5.4 | 7.1 | 6.9 | 9.5 | 9.0 | 8.6 |
| flavor Y (point) | 5.2 | 7.0 | 6.8 | 9.5 | 8.5 | 8.1 |
| moldability (point) | 10.0 | 10.0 | 10.0 | 10.0 | 10.0 | 10.0 |

X: a freshly cooked food
Y: re-heated after freezing

As shown in Examples 2-A and 2-B, there was also a relation between a water absorbing capacity and a soft and juicy mouthfeel, and there was a tendency that, as a water absorbing capacity became larger, a more juicy mouthfeel was obtained. As shown in the textured proteins A1 and A3, and the processed foods H1 (1) and H3 (1), a juicy mouthfeel was hardly improved by using powdered soybean protein instead of defatted soybeans as the raw material for soybean protein, though a flavor was better. However, as shown in the textured proteins A2 and A4, and the processed foods H2 (1) and H4 (1), when using casein-Na together, a flavor was better, and a soft and juicy mouthfeel was remarkably increased. On the other hand, as shown in the textured proteins A5 and A6, and the processed foods H5 (1) and H6 (1), when adding an oil, expanding of a textured protein was suppressed, and a water absorbing capacity and an effect of giving a juicy mouthfeel were decreased as the amount of oil added was increased. The textured protein A6 to which 10% of oil was added had a level close to the textured product A1 (a conventional level) and was not good.

### EXAMPLE 3

This Example shows the comparison of formulations and includes Comparative Examples.

### EXAMPLE 3-A

Textured proteins were obtained by feeding the formulations shown in Table 6 to an extruder. Each textured protein was evaluated according to the above “evaluation of textured protein alone”.

TABLE 6

| | textured protein | | | | | |
|---|---|---|---|---|---|---|
| | A7 | A8 | A9 | A10 | A11 | A12 |
| (formulation of raw | | | | | | |
| materials (%)) | | | | | | |
| powdered soybean protein | 85 | 85 | 85 | 68 | 80 | — |
| wheat gluten | 15 | — | — | — | — | — |
| WPC | — | 15 | — | — | — | — |
| MPC | — | — | 15 | — | — | — |
| casein-Na | — | — | — | 12 | — | 100 |
| starch | — | — | — | 20 | 20 | — |
| (evaluation) | | | | | | |
| water absorbing capacity | 2.1 | 2.0 | 4.8 | 9.4 | 4.9 | 0.8 |
| (fold) | | | | | | |
| soft mouthfeel (point) | 4.6 | 5.0 | 7.1 | 9.8 | 7.1 | 2.9 |
| flavor (point) | 1.3 | 7.4 | 3.4 | 9.5 | 8.2 | 1.4 |

### EXAMPLE 3-B

Each textured protein obtained in Example 3-A and water was mixed with 21.0 g of ground pork, 23.0 g of ground beef, 3.5 g of lard, 20.0 g of onion, 2.5 g of frozen whole egg, 2.5 g of fresh cream, 5.0 g of bread crumbs, 2.0 g of seasonings and 0.5 g of spices to prepare 100 g of hamburger dough, which was evaluated according to the above “evaluation of textured protein in mixture (processed food—hamburger)”.

TABLE 7
(unit: g)

| | processed food | | | | | |
|---|---|---|---|---|---|---|
| | H7 | H8 | H9 | H10 | H11 | H12 |
| | (1) | (1) | (1) | (1) | (1) | (2) |
| water-reconstituted | 20.0 | 20.0 | 20.0 | 20.0 | 20.0 | 20.0 |
| textured protein | | | | | | |
| (water) | 13.3 | 13.3 | 16.7 | 17.8 | 16.7 | 10.0 |
| (textured protein A7) | 6.7 | — | — | — | — | — |
| (textured protein A8) | — | 6.7 | — | — | — | — |
| (textured protein A9) | — | — | 3.3 | — | — | — |
| (textured protein A10) | — | — | — | 2.2 | — | — |
| (textured protein A11) | — | — | — | — | 3.3 | — |
| (textured protein A12) | — | — | — | — | — | 10.0 |
| juicy mouthfeel X | 9.7 | 9.6 | 9.6 | 9.7 | 9.6 | 9.5 |
| (point) | | | | | | |
| juicy mouthfeel Y | 3.4 | 2.9 | 7.8 | 9.6 | 4.4 | 1.4 |
| (point) | | | | | | |
| soft mouthfeel X | 4.8 | 4.7 | 7.3 | 9.5 | 7.2 | 3.3 |
| (point) | | | | | | |
| soft mouthfeel Y | 4.5 | 4.5 | 7.1 | 9.5 | 7.0 | 3.3 |
| (point) | | | | | | |
| flavor X (point) | 5.3 | 7.4 | 3.9 | 9.8 | 7.2 | 2.2 |
| flavor Y (point) | 5.2 | 7.2 | 3.5 | 9.8 | 6.9 | 1.8 |
| moldability (point) | 10.0 | 10.0 | 10.0 | 10.0 | 10.0 | 10.0 |

X: a freshly cooked food
Y: re-heated after freezing

As shown in the textured proteins A7 and A8, and the processed foods H7 (1) and H8 (1), the use of a wheat gluten and WPC resulted in a smaller water absorbing capacity, no soft mouthfeel, and no juicy mouthfeel after freezing and re-heating. And also, as shown in the textured protein A9 and the processed food H9 (1), a soft and juicy mouthfeel was slightly added by using MPC, but a strong undesired milk flavor was developed. Further, the textured product A11 and the processed food H11 (1), in which only starch was used instead of casein-Na, had a soft mouthfeel but did not maintain a sufficient juicy mouthfeel. On the other hand, as shown in the textured protein A10 and the processed food H10 (1), a juicy mouthfeel was maintained sufficiently by using casein-Na, even when a starch was mixed. As shown in the textured protein A12 and the processed food H12 (1), when soybean protein was not used and only casein-Na was used, the product was hardly textured but turned into caramel, had a strong milk flavor, and did not give a soft and juicy mouthfeel to the hamburger.

### EXAMPLE 4

### EXAMPLE 4-A

Textured proteins were obtained by feeding the formulations shown in Table 8 to an extruder. Each textured protein obtained was evaluated according to the above “evaluation of textured protein alone”.

TABLE 8

| | textured protein | | | | | |
|---|---|---|---|---|---|---|
| | A3 | A13 | A4 | A14 | A15 | A16 |
| (formulation of raw | | | | | | |
| materials (%)) | | | | | | |
| powdered soybean protein | 100 | 95 | 85 | 60 | 40 | 15 |
| casein-Na | — | 5 | 15 | 40 | 60 | 85 |
| water absorbing capacity | 4.9 | 6.8 | 7.1 | 7.4 | 6.0 | 3.1 |
| (fold) | | | | | | |
| soft mouthfeel (point) | 5.0 | 9.6 | 9.5 | 9.4 | 6.0 | 3.7 |
| flavor (point) | 6.7 | 9.0 | 9.5 | 8.5 | 5.4 | 2.1 |

### EXAMPLE 4-B

Each textured product obtained in Example 4-A and water was mixed with 21.0 g of ground pork, 23.0 g of ground beef, 3.5 g of lard, 20.0 g of onion, 2.5 g of frozen whole egg, 2.5 g of fresh cream, 5.0 g of bread crumbs, 2.0 g of seasonings and 0.5 g of spices as shown in Table 9 to prepare 100 g of hamburger dough, which was evaluated according to the above “evaluation of textured protein in mixture (processed food—hamburger)”.

TABLE 9
(unit: g)

| | processed food | | | | | |
|---|---|---|---|---|---|---|
| | H3 | H13 | H4 | H14 | H15 | H16 |
| | (1) | (1) | (1) | (1) | (1) | (1) |
| water-reconstituted | 20.0 | 20.0 | 20.0 | 20.0 | 20.0 | 20.0 |
| textured protein | | | | | | |
| (water) | 16.6 | 17.4 | 17.5 | 17.5 | 17.1 | 15.1 |
| (textured protein A3) | 3.4 | — | — | — | — | — |
| (textured protein A13) | — | 2.6 | — | — | — | — |
| (textured protein A4) | — | — | 2.5 | — | — | — |
| (textured protein A14) | — | — | — | 2.4 | — | — |
| (textured protein A15) | — | — | — | — | 2.9 | — |
| (textured protein A16) | — | — | — | — | — | 4.9 |
| juicy mouthfeel X | 9.5 | 9.8 | 9.8 | 9.5 | 9.5 | 9.6 |
| (point) | | | | | | |
| juicy mouthfeel Y | 4.2 | 9.4 | 9.6 | 9.5 | 6.2 | 2.9 |
| (point) | | | | | | |
| soft mouthfeel X | 6.2 | 9.5 | 9.6 | 9.5 | 6.3 | 3.8 |
| (point) | | | | | | |
| soft mouthfeel Y | 5.1 | 9.5 | 9.6 | 9.5 | 6.4 | 3.6 |
| (point) | | | | | | |
| flavor X (point) | 6.9 | 9.5 | 9.5 | 8.7 | 5.4 | 2.4 |
| flavor Y (point) | 6.8 | 9.5 | 9.5 | 8.5 | 5.1 | 2.3 |
| moldability (point) | 10.0 | 10.0 | 10.0 | 10.0 | 10.0 | 10.0 |

X: a freshly cooked food

Y: Re-Heated After Freezing

Textured proteins A13, A4 and A14 had large water absorbing capacities and the resultant processed foods H13 (1), H4 (1) and H14 (1) had a soft and juicy mouthfeel after freezing and re-heating. The processed food H3 (1), in which the textured protein A3 containing no casein-Na was used had a less juicy and soft mouthfeel. In addition, when an amount of casein-Na added was increased from 15% to 40%, a little milk flavor was recognized. When an amount of casein-Na added was increased to 60% of the textured protein A15, a milk flavor was recognized to some extent even a water absorbing capacity was relatively large, and the processed food H15 (1) had a tendency of slightly decreased in a soft and juicy mouthfeel. When the amount of casein-Na added was increased to 85% as in the textured protein A16, it was hardly expanded, and had a small water absorbing capacity with an undesirable milk flavor. The processed food H16 (1) had a less soft and juicy mouthfeel.

From these results, it has been found that, in order to obtain an effect of giving a soft and juicy mouthfeel, the ratio of powdered soybean protein/casein-Na is 98/2 to 35/65, preferably 98/2 to 45/55, more preferably 93/7 to 70/30.

### EXAMPLE 5

### EXAMPLE 5-A

Textured proteins were obtained by feeding the formulations as shown in Table 10 to an extruder. Each textured protein obtained was evaluated according to the above “evaluation of textured protein alone”.

TABLE 10

| | textured protein | | | | |
|---|---|---|---|---|---|
| | A4 | A17 | A10 | A18 | A19 |
| (formulation of raw | | | | | |
| materials (%)) | | | | | |
| powdered soybean protein | 85 | 77 | 68 | 51 | 17 |
| casein-Na | 15 | 13 | 12 | 9 | 3 |
| starch | — | 10 | 20 | 40 | 80 |
| water absorbing capacity | 7.1 | 8.0 | 9.4 | 7.5 | 4.5 |
| (fold) | | | | | |
| soft mouthfeel (point) | 9.6 | 9.7 | 9.8 | 8.1 | 5.1 |
| flavor (point) | 9.5 | 9.7 | 9.5 | 9.7 | 9.8 |

### EXAMPLE 5-B

Each textured product obtained in Example 5-A and water was mixed with 21.0 g of ground pork, 23.0 g of ground beef, 3.5 g of lard, 20.0 g of onion, 2.5 g of frozen whole egg, 2.5 g of fresh cream, 5.0 g of bread crumbs, 2.0 g of seasonings and 0.5 g of spices as shown in Table 11 to prepare 100 g of hamburger dough, which was evaluated according to the above “evaluation of textured protein in mixture (processed food—hamburger)”.

TABLE 11
(unit: g)

| | processed food | | | | |
|---|---|---|---|---|---|
| | H4 | H17 | H10 | H18 | H19 |
| | (1) | (1) | (1) | (1) | (1) |
| water-reconstituted | 20.0 | 20.0 | 20.0 | 20.0 | 20.0 |
| textured protein | | | | | |
| (water) | 17.5 | 17.5 | 17.5 | 17.3 | 16.4 |
| (textured protein A4) | 2.5 | — | — | — | — |
| (textured protein A17) | — | 2.5 | — | — | — |
| (textured protein A10) | — | — | 2.5 | — | — |
| (textured protein A18) | — | — | — | 2.7 | — |
| (textured protein A19) | — | — | — | — | 3.6 |
| juicy mouthfeel X | 9.8 | 9.8 | 9.7 | 8.9 | 5.6 |
| (point) | | | | | |
| juicy mouthfeel Y | 9.6 | 9.7 | 9.6 | 8.5 | 4.5 |
| (point) | | | | | |
| soft mouthfeel X (point) | 9.6 | 9.7 | 9.5 | 8.6 | 4.9 |
| soft mouthfeel Y (point) | 9.6 | 9.5 | 9.5 | 8.4 | 4.7 |
| flavor X (point) | 9.5 | 9.6 | 9.8 | 9.6 | 9.5 |
| flavor Y (point) | 9.5 | 9.6 | 9.8 | 9.5 | 9.5 |
| moldability (point) | 10.0 | 10.0 | 10.0 | 9.0 | 8.5 |

X: a freshly cooked food
Y: re-heated after freezing

A series of starch-added textured proteins A17 and A10 had similar water absorbing capacities as that of the textured protein A4 to which no starch was added. All the processed foods H4 (1), H17 (1) and H10 (1) had a juicy and soft mouthfeel after freezing and re-heating. The textured protein A18 had a water absorbing capacity, and the processed food H18 (1) had a soft and juicy mouthfeel, but also had a slightly gooey mouthfeel of starch. The textured protein A19 had a small water absorbing capacity, and the processed food H19 (1) had a weak soft and juicy mouthfeel, but had an undesired characteristic gooey mouthfeel of starch. A juicy mouthfeel was obtained even when no starch was added.

From these results, it has been found that, in order to obtain an effect of giving a juicy mouthfeel, starch content is not more than 60%, preferably not more than 30%.

### EXAMPLE 6

Each of textured proteins A1, A2, A3 and A4 obtained in Example 2-A and water were mixed with 35.0 g of ground beef, 22.0 g of ground pork, 12.0 g of lard, 12.0 g of onion, 5.0 g of bread crumbs, 5.0 g of potato starch, 2.5 g of frozen whole egg, 3.0 g of seasonings and 1.0 g of spices as shown in Table 12 to prepare 100 g of meatball dough, which was evaluated according to the above “evaluation of textured protein in mixture (processed food—meatball)”.

TABLE 12
(unit: g)

| | processed food. | | | | |
|---|---|---|---|---|---|
| | M0 | M1 | M2 | M3 | M4 |
| | (1) | (1) | (1) | (1) | (1) |
| water-reconstituted | — | 20.0 | 20.0 | 20.0 | 20.0 |
| textured protein | | | | | |
| (water) | — | 15.1 | 17.1 | 16.6 | 17.5 |
| (textured protein A1) | — | 4.9 | — | — | — |
| (textured protein A2) | — | — | 2.9 | — | — |
| (textured protein A3) | — | — | — | 3.4 | — |
| (textured protein A4) | — | — | — | — | 2.5 |
| juicy mouthfeel X (point) | 9.6 | 9.5 | 9.6 | 9.5 | 9.7 |
| juicy mouthfeel Y (point) | 3.8 | 3.6 | 7.8 | 4.4 | 9.5 |
| soft mouthfeel X (point) | 3.8 | 4.8 | 7.0 | 5.8 | 9.6 |
| soft mouthfeel Y (point) | 3.4 | 4.7 | 7.0 | 5.5 | 9.4 |
| flavor X (point) | 9.5 | 3.8 | 7.3 | 6.9 | 9.4 |
| flavor Y (point) | 9.5 | 3.8 | 7.2 | 6.7 | 9.3 |
| moldability (point) | 10.0 | 10.0 | 10.0 | 10.0 | 10.0 |

As with hamburgers, in meatballs, the processed food M4 (1) had good flavor and maintained a good soft and juicy mouthfeel after freezing and re-heating.

From this, it has been found that the similar effect was obtained in meatballs even after the steps of frying, boiling, freezing and re-heating.

### EXAMPLE 7

Each of the textured proteins A1, A2, A3 and A4 obtained in Example 2-A and water were mixed with 30.0 g of ground pork, 10.0 g of lard, 37.0 g of cabbage, 14.0 g of onion, 3.5 g of bread crumbs, 1.0 g of chive, 1.5 g of sesame oil, 2.0 g of seasonings and 1.0 g of spices as shown in Table 13 to prepare 100 g of jiao-zi dough, which was evaluated according to the above “evaluation of textured protein in mixture (processed food—jiao-zi)”.

TABLE 13
(unit: g)

| | G0 | G1 | G2 | G3 | G4 |
|---|---|---|---|---|---|
| processed food | (1) | (1) | (1) | (1) | (1) |
| water-reconstituted | — | 2.0 | 2.0 | 2.0 | 2.0 |
| textured protein | | | | | |
| (water) | — | 15.1 | 17.1 | 16.6 | 17.5 |
| (textured protein A1) | — | 4.9 | — | — | — |
| (textured protein A2) | — | — | 2.9 | — | — |
| (textured protein A3) | — | — | — | 3.4 | — |
| (textured protein A4) | — | — | — | — | 2.5 |
| juicy mouthfeel X | 9.7 | 9.7 | 9.6 | 9.5 | 9.8 |
| (point) | | | | | |
| juicy mouthfeel Y | 3.6 | 3.5 | 7.4 | 4.3 | 9.7 |
| (point) | | | | | |
| soft mouthfeel X (point) | 3.9 | 4.9 | 6.8 | 5.3 | 9.2 |
| soft mouthfeel Y (point) | 3.8 | 4.8 | 6.7 | 5.2 | 9.1 |
| flavor X (point) | 9.7 | 3.8 | 4.9 | 6.7 | 9.6 |
| flavor Y (point) | 9.5 | 3.5 | 4.7 | 6.5 | 9.5 |
| moldability (point) | 10.0 | 10.0 | 10.0 | 10.0 | 10.0 |

As with hamburgers, in jiao-zi, the processed food G4 (1) had good flavor and maintained a good soft and juicy mouthfeel after freezing and re-heating.

From this, it was found that the similar effect was obtained in jiao-zi even after the steps of encrusting, boiling, freezing and re-heating by baking.

According to the present invention, it is possible to produce a textured protein which is capable of giving a juicy mouthfeel of a freshly cooked food to a processed meat product even if the processed meat product is re-heated upon eating after being frozen and distributed to the market. Although casein protein alone cannot be textured, when casein protein is used together with soybean protein according to the present invention, such a mixture can be expanded to incorporate a large amount of water into the mixture. Then, the mixture can be used for giving a juicy mouthfeel to a processed meat product, which makes it possible to offer a processed meat product in the high-quality finished form to consumers.

1. A textured protein comprising as main ingredients soybean, casein and water, which is obtained by heating a mixture of raw materials comprising soybean protein, casein and water under pressure, and extruding the mixture into the atmosphere to expand.

2. The textured protein according to claim 1, wherein a ratio of soybean protein/casein in the raw materials is 98/2 to 35/65 (dry solids weight ratio).

3. The textured protein according to claim 1, which further comprises starch in an amount of not more than 60% by weight based on dry solids of the raw materials.

4. The textured protein according to claim 1, wherein the textured protein has a 5- to 12-fold by weight water absorbing capacity.

5. The textured protein according to claim 1, whose oil content is not more than 3% by weight based on dry solids of the raw materials.

6. A process for producing a textured protein comprising as main ingredients soybean protein, casein and water, which comprises the steps of:
preparing a mixture of raw materials comprising soybean protein, casein and water, heating the mixture under pressure, and extruding the mixture to the atmosphere to expand.

7. The process according to claim 6, wherein a ratio of soybean protein/casein in the raw materials is 98/2 to 35/65 (dry solids weight ratio).

8. The process according to claim 6, wherein starch is further included in the mixture of the raw materials in an amount of not more than 60% by weight based on dry solids of the raw materials.

9. The process according to claim 6, wherein the textured protein obtained has a 5- to 12-fold by weight water absorbing capacity.

10. The process according to claim 6, wherein an oil content of the mixture is not more than 3% by weight based on dry solids of the raw materials.

11. A process for producing a processed food which comprises the steps of:
mixing the textured protein according to claim 1 and raw materials of the processed food, and molding, cooking and then freezing the resulting mixture.
